(19) United States
(12) Patent Application Publication
(10) Pub. No.: US 2026/0040052 A1
(43) Pub. Date: Feb. 5, 2026

(54) STORAGE AND RETRIEVAL OF A UNIQUE IDENTIFIER OF A USER EQUIPMENT

(71) Applicant: T-MOBILE INNOVATIONS LLC, Overland Park, KS (US)

(72) Inventors: Anil Kumar MARIYANI, Ashburn, VA (US); Lin ZHANG, Overland Park, KS (US); Anuj SHARMA, Broadlands, VA (US)

(21) Appl. No.: 18/794,816

(22) Filed: Aug. 5, 2024

(51) Int. Cl. H04W 8/18

(52) U.S. Cl. CPC H04W 8/183

(57) ABSTRACT

Embodiments of the present disclosure are directed to systems and methods for storing a unique identifier of a user equipment on a communication network and retrieving the unique identifier for use by an application on the user equipment. In this way, operators can utilize non-native applications similarly to native applications, which can be beneficial for verification purposes without user intervention, enhancing the user experience and making the service more seamless and attractive.

### SUMMARY

The present disclosure is directed, in part, to storing a unique identifier of a user equipment on a communication network and retrieving the unique identifier for use by an application on the user equipment, substantially as shown and/or described in connection with at least one of the figures, and as set forth more completely in the claims.

According to various aspects of the technology, communication networks typically provide a range of services, including voice, text, and data transmissions (e.g., collectively referred to as a data call) to facilitate communication among users. In the context of over-the-top (OTT) applications, making a data call typically requires a user to manually input their phone number (e.g., mobile station international subscriber directory number (MSISDN)) to verify and authenticate the user's identity to ensure the security and integrity of the service. This often involves sending a verification code via text to the user's phone, which the user must then enter into the application. OTT applications frequently use the phone number as a unique identifier to connect with other users. By inputting their phone number, users allow the application to link their account with their contacts who also use the service. While this method may help secure user identification and connectivity, it introduces an additional step that can be cumbersome and less user-friendly. To address this issue, an OTT application may be integrated as a native application in the communication network. When integrating OTT applications into native video calling services provided by a communication network, this manual input requirement poses a significant challenge. Accordingly, the present solution involves systems and methods for storing the unique identifier and automatically retrieving the unique identifier for verification purposes without user intervention, enhancing the user experience and making the service more seamless and attractive.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

FIG. 1 illustrates an exemplary computing device for use with the present disclosure;

FIG. 2 illustrates a diagram of an exemplary network environment in which implementations of the present disclosure may be employed;

FIG. 3 illustrates an example flow diagram in which implementations of the present disclosure may be employed;

FIG. 4 illustrates a flow chart of an exemplary method for providing an application on a user equipment with a unique identifier of the user equipment in which implementations of the present disclosure may be employed;

FIG. 5 illustrates a flow chart of an exemplary method for retrieving a unique user equipment identifier from a communication network in which implementations of the present disclosure may be employed; and

FIG. 6 illustrates a flow chart of an exemplary method for retrieving a unique user equipment identifier from a communication network for use in an application on the user equipment in which implementations of the present disclosure may be employed.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

The example aspects and embodiments described in the present disclosure are provided within the context of a wireless telecommunication network for illustrative purposes. However, it should be understood that the principles and techniques discussed herein are not limited to wireless networks alone. The concepts and methodologies can be equally applied to other types of communication networks, including but not limited to wired, satellite, and optical networks. These alternative networks are capable of supporting the functionalities and applications described, and their use falls within the scope of the present disclosure.

As used herein, the term “base station” refers to a centralized component or system of components that is configured to wirelessly communicate (receive and/or transmit signals) with a plurality of stations (i.e., wireless communication devices, also referred to herein as user equipment (UE(s))) in a particular geographic area. As used herein, the term “network access technology (NAT)” is synonymous with wireless communication protocol and is an umbrella term used to refer to the particular technological standard/protocol that governs the communication between a UE and a base station; examples of network access technologies include 3G, 4G, 5G, 6G, 802.11x, and the like.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions-including data structures and program modules—in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

By way of background, user equipment such as smartphones and tablets may have applications that can be broadly categorized into native applications and non-native (e.g., OTT) applications. Both types of applications may serve distinct purposes and may be implemented differently, for example, by leveraging various aspects of the device's hardware and software capabilities. Native applications may be developed specifically for a particular operating system (OS) such as Android or iOS. These applications may be built using platform-specific programming languages and may be installed directly on the device. They have direct access to the device's hardware and system resources, which may allow them to deliver high performance and a seamless user experience. On the other hand, non-native applications may operate independently of the device's native services and are typically developed using web technologies or cross-platform frameworks. These applications may run over the internet and may provide services such as messaging, video calls, and streaming (e.g., a data call) without relying on the communication network's infrastructure.

Conventionally, a native application may be integrated into the device's OS and may be designed to work seamlessly with the device's native functionalities such as the contact list and message system. In contrast, a non-native application such as Google Meet, WhatsApp, or Skype may operate over the internet and can be used across different devices and platforms. While these applications may provide flexibility and a wide range of features, they often require the user to manually input contact information and set up accounts separately from the device's native services.

To address this issue, the present disclosure is directed to systems and methods for providing an application (e.g., an OTT application) on a user equipment with a unique equipment identifier (e.g., MSISDN) of the user equipment for use by the application. For example, an application programming interface (API) between the application and a communication network (e.g., 4G/5G unified data repository (UDR)) servicing the user equipment may be established. This new interface may enable the application to retrieve, or the communication network to provide, the unique equipment identifier from the communication network and for the unique equipment identifier to be stored locally since the application has an interface to communicate with the communication network. When the user equipment attaches to the communication network (e.g., 4G/5G network) and secures a data session during a setup process, the communication network may assign an identifier (e.g., an internet protocol (IP) address) to the user equipment, which may be leveraged to retrieve the unique identifier. For example, during the attachment process, the identifier assigned to the user equipment may be stored in the communication network (e.g., 4G/5G UDR) and a mapping of the identifier to the unique identifier may also be stored in the communication network (e.g., 4G/5G UDR). The API established between the application and the communication network (e.g., a 5G Network Data Repository Function (NUDR) interface or a Lightweight Directory Access Protocol (LDAP) interface) may allow the application to retrieve, or the communication network to provide for the application, the unique identifier (e.g., MSISDN) based on the assigned identifier (e.g., IP address), thereby eliminating the need for manual input of a phone number. In this way, operators can utilize non-native applications similarly to native applications since a centralized location (e.g., 4G/5G UDR) may be used to store and map the unique identifier (e.g., MSISDN) and the identifier (e.g., IP address), which can be leveraged as a multi-factor authentication for the application. Additionally, operators will be able to make data calls utilizing such applications on devices irrespective of OS types. Accordingly, an operator could designate an application that originated on the user equipment as a non-native application to become a native application. For example, the application could be verified against a list of approved applications to establish the interface with the communication network and become a native application.

Accordingly, it can be appreciated that the term “native application” may refer to an application that has been integrated, or is designated to be integrated, into a communication network in order to provide the benefits discussed. For example, an application may be verified as a native application (e.g., integrated) or on a list of approved applications (e.g., designated to be integrated).

Accordingly, a first aspect of the present disclosure is directed to a system for providing an application on a user equipment with a unique identifier of the user equipment. The system includes a network storage device and a network device comprising one or more processors. The system further includes a non-transitory computer-readable media configured to receive a request from the application on the user equipment to provide the unique identifier of the user equipment to the application that includes an identifier of the user equipment that is different from the unique identifier. The computer-readable media is further configured to retrieve the unique identifier of the user equipment based on the identifier in the request and to provide the application with the unique identifier of the user equipment.

A second aspect of the present disclosure is directed to a non-transitory computer-readable media that, when executed, cause a user equipment comprising one or more processors to perform operations for retrieving a unique user equipment identifier from a communication network. For example, the computer-readable media is configured to receive a request from an application on the user equipment to initiate a call and to request, from the communication network, a configuration to initiate the call, the request comprising an identifier of the user equipment that is different from the unique user identifier. The computer-readable media is further configured to receive, from the communication network, the unique user device identifier of the user equipment based on the provided identifier and to provide the unique user equipment identifier to the application.

A third aspect of the present disclosure is directed to a method for retrieving a unique user equipment identifier from a communication network for use in an application on a user equipment. The method includes receiving a user input to initiate a call at the application and requesting, from the communication network, a configuration to initiate the call, the request comprising an identifier of the user equipment that is different from the unique user equipment identifier. The method further includes receiving, from the communication network, the unique user device identifier of the user equipment based on the provided identifier.

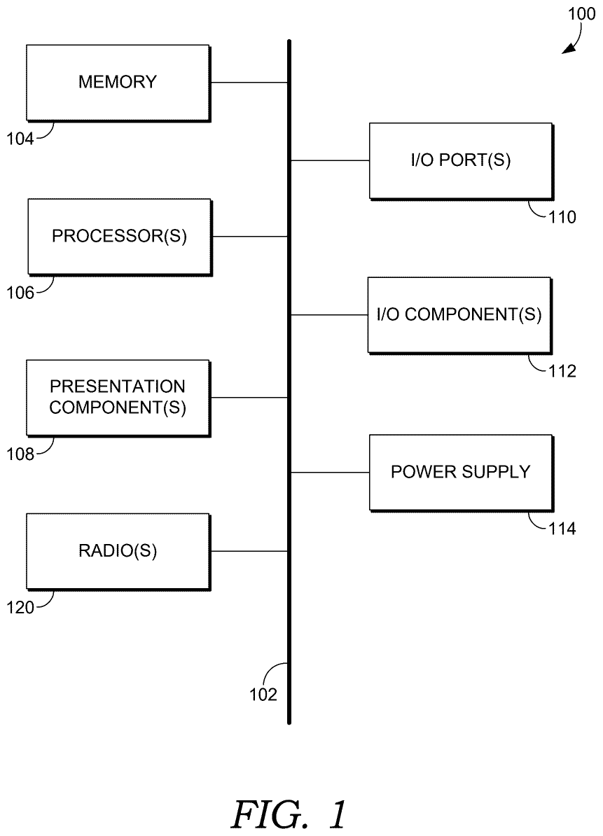

Referring to FIG. 1, an exemplary computer environment is shown and designated generally as computing device 100 that is suitable for use in implementations of the present disclosure. Computing device 100 is but one example of a suitable computing environment and is not intended to suggest any limitation as to the scope of use or functionality of the invention. Neither should computing device 100 be interpreted as having any dependency or requirement relating to any one or combination of components illustrated. In aspects, the computing device 100 is generally defined by its capability to transmit one or more signals to an access point and receive one or more signals from the access point (or some other access point); the computing device 100 may be referred to herein as a user equipment (UE), wireless communication device, or user device, The computing device 100 may take many forms; non-limiting examples of the computing device 100 include a fixed wireless access device, cell phone, tablet, internet of things (IOT) device, smart appliance, automotive or aircraft component, pager, personal electronic device, wearable electronic device, activity tracker, desktop computer, laptop, PC, and the like.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 1, computing device 100 includes bus 102 that directly or indirectly couples the following devices: memory 104, one or more processors 106, one or more presentation components 108, input/output (I/O) ports 110, I/O components 112, and power supply 114. Bus 102 represents what may be one or more busses (such as an address bus, data bus, or combination thereof). Although the devices of FIG. 1 are shown with lines for the sake of clarity, in reality, delineating various components is not so clear, and metaphorically, the lines would more accurately be grey and fuzzy. For example, one may consider a presentation component such as a display device to be one of I/O components 112. Also, processors, such as one or more processors 106, have memory. The present disclosure hereof recognizes that such is the nature of the art, and reiterates that FIG. 1 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 1 and refer to “computer” or “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media of the computing device 100 may be in the form of a dedicated solid state memory or flash memory, such as a subscriber information module (SIM). Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 104 includes computer-storage media in the form of volatile and/or nonvolatile memory. Memory 104 may be removable, nonremovable, or a combination thereof. Exemplary memory includes solid-state memory, hard drives, optical-disc drives, etc. Computing device 100 includes one or more processors 106 that read data from various entities such as bus 102, memory 104 or I/O components 112. One or more presentation components 108 presents data indications to a person or other device. Exemplary one or more presentation components 108 include a display device, speaker, printing component, vibrating component, etc. I/O ports 110 allow computing device 100 to be logically coupled to other devices including I/O components 112, some of which may be built in computing device 100. Illustrative I/O components 112 include a microphone, joystick, game pad, satellite dish, scanner, printer, wireless device, etc.

The radio 120 represents one or more radios that facilitate communication with one or more wireless networks using one or more wireless links. While a single radio 120 is shown in FIG. 1, it is expressly contemplated that there may be more than one radio 120 coupled to the bus 102. In aspects, the radio 120 utilizes a transmitted to communicate with a wireless telecommunications network. It is expressly contemplated that a computing device 100 with more than one radio 120 could facilitate communication with the wireless network via both the first transmitter and additional transmitters (e.g. a second transmitter). Illustrative wireless telecommunications technologies include CDMA, GPRS, TDMA, GSM, and the like. The radio 120 may carry wireless communication functions or operations using any number of desirable wireless communication protocols, including 802.11 (Wi-Fi), WiMAX, LTE, 3G, 4G, LTE, 5G, NR, VoLTE, or other VoIP communications. As can be appreciated, in various embodiments, radio 120 can be configured to support multiple technologies and/or multiple radios can be utilized to support multiple technologies. A wireless telecommunications network might include an array of devices, which are not shown as to obscure more relevant aspects of the invention. Components such as a base station or communications tower (as well as other components) can provide wireless connectivity in some embodiments.

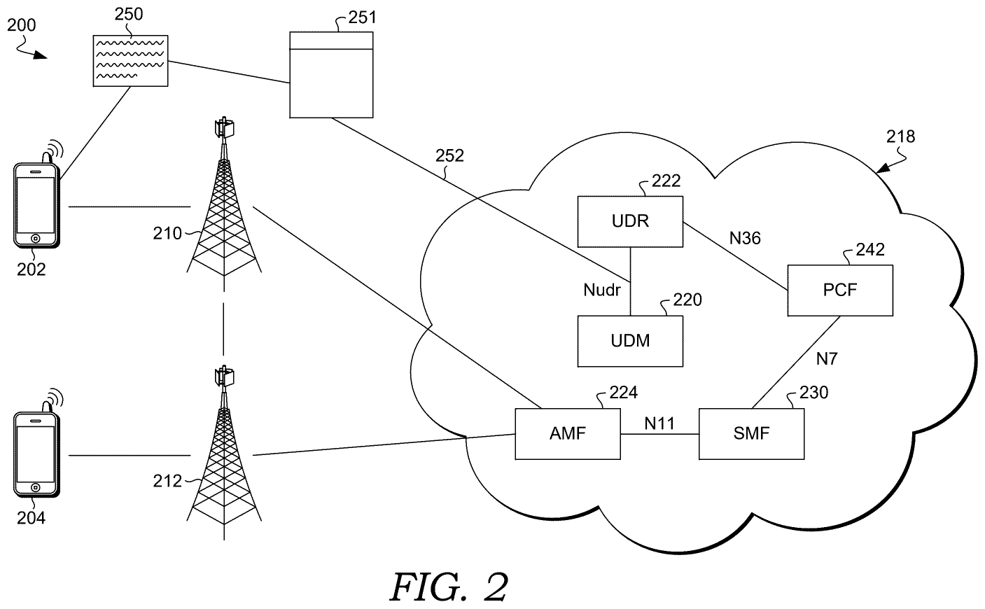

Referring now to FIG. 2, an exemplary network environment is illustrated in which implementations of the present disclosure may be employed. Such a network environment is illustrated and designated generally as network environment 200. Network environment 200 is but one example of a suitable network environment and is not intended to suggest any limitation as to the scope of use or functionality of the invention. Neither should the network environment be interpreted as having any dependency or requirement relating to any one or combination of components illustrated.

Network environment 200 represents a high level and simplified view of relevant portions of a modern wireless telecommunication network. At a high level, the network environment 200 may generally be said to comprise one or more UEs, such as UE 202 and/or a second UE 204, one or more base stations, such as a first base station 210 and/or a second base station 212, and a core network 218, though in some implementations, it may not be necessary for certain features to be present. For example, in some aspects, the network environment 200 may not comprise the second base station 212 where the first UE 202 and the second UE 204 connect to the first base station 210. In other aspects, the network environment 200 may not comprise the second base station 212 or the second UE 204. The network environment may include a number of routers, switches, and the like. The network environment 200 is generally configured for wirelessly connecting the first UE 202 and/or the second UE 204 to data or services that may be accessible on one or more application servers or other functions, nodes, or servers not pictured in FIG. 2 so as to not obscure the focus on the present disclosure.

The network environment 200 comprises one or more of the first UE 202 and the second UE 204. The first UE 202 and the second UE 204 are illustrated generally, and may take any number of forms, including a tablet, phone, or wearable device, or any other device discussed with respect to FIG. 1 and may have any one or more components or features of the computing device 100 of FIG. 1. In some aspects, the first UE 202 and/or the second UE 204 may not be a conventional telecommunications devices (i.e., a device that is capable of placing and receiving voice calls), but may instead take the form of devices that only utilizes wireless network resources in order to transmit or receive data; such devices may include IoT devices (e.g., smart appliances, thermostats, locks, smart speakers, lighting devices, smart receptacles, and the like).

The first UE 202 and/or the second UE 204 may possess a unique identifier for various network operations and services. In some aspects, the unique identifier may include a MSISDN, an International Mobile Subscriber Identity (IMSI), or an International Mobile Equipment Identity (IMEI). In other aspects, the unique identifier may include a device or session identifier such as an IP address. The MSISDN, which may be referred to as a phone number, may be used for reaching a specific user equipment within the network (e.g., UE 202), within the network, enabling voice calls, SMS messaging, and other communication services (e.g., a data call). The IMSI is a globally unique identifier assigned to the SIM card within the user equipment and allows network operators to associate subscribers with their respective accounts and service profiles. The IMEI serves as a unique identifier for the device hardware itself. Each of these may serve as the unique identifier for purposes of the present disclosure.

The network environment 200 comprises one or more of the first base station 210 and/or the second base station 212 to which the first UE 202 and the second UE 204 may potentially connect to (also referred to as ‘camping on,’ ‘attaching,’ in the industry). Though network environment 200 is illustrated with both the first base station 210 and the second base station 212, one skilled in the art will appreciate that more or fewer base stations may be present in any particular network environment. Each of the first base station 210 and the second base station 212 of the network environment 200 is configured to wirelessly communicate with UEs, such as the first UE 202 and/or the second UE 204. In aspects, any of first base station 210 and the second base station 212 may communicate with one or more of the first UE 202 and/or the second UE 204 using any wireless telecommunication protocol desired by a network operator, including but not limited to 3G, 4G, 5G, 6G, 802.11x and the like.

One or more network functions (NFs) of the core network 218 may communicate messages across the core network 218 to other NFs of the core network 218. As used herein, the term “network function” is used to describe a computer processing module and/or one or more computer executable services being executed on one or more computing processing modules. It should be appreciated that, while the network environment 200 is described in the context of a 5G environment, the same concepts may apply in other environments, such as a 4G environment. For example, the core network 218 may comprise NFs that include any one or more of a unified data management function (UDM) 220, a unified data repository (UDR) 222, an access and mobility management function (AMF) 224, a session management function (SMF) 230, and a policy control function (PCF) 242. Notably, the preceding nomenclature is used with respect to the 3GPP 5G architecture; in other aspects each of the preceding NFs may take different forms, including consolidated or distributed forms that perform the same general operations. For example, the PCF 242 in the 3GPP 5G architecture is generally configured for various functions relating to policy management and enforcement; in other forms, such as a 4G architecture, the PCF 242 of FIG. 2 may take the form of a policy and charging rules function (PCRF). Additionally, depending on the network architecture, the UDM 220 and the UDR 222 may be integrated into a single platform or deployed as separate components. Accordingly, in some aspects, references to the UDM 220 or the UDR 222 may be a reference to both components in terms of functionality. In some architectures or protocols, the NFs may be given other names, however, the NFs herein refer to functions, not specifically identified components. Though the UDM 220, the UDR 222, the AMF 224, the SMF 230, and the PCF 242 are illustrated in the core network 218, the core network 218 may have more or fewer NFs than shown. For example, the core network 218 may include a network slice selection function (NSSF). Further, though the UDM 220, the UDR 222, the AMF 224, the SMF 230, and the PCF 242 are illustrated as disposed within the core network 218, it is expressly contemplated that the location in the network environment 200 is non-limiting. For example, the NFs described above may be disposed between the first base station 210 and/or the second base station 212 and the core network 218 (i.e., the network edge) or may be isolated as stand-alone components, or a combination of these.

The network core 218 is a service-based architecture and contains NFs defined by their function. The UDM 220, for example, is generally responsible for managing user data within the network. The UDR 222, for example, acts as a storage repository for various types of user-related data. The AMF 224, for example, is generally responsible for managing registration and mobility of UEs, such as the first UE 202 and/or the second UE 204, and achieves this by coordinating signaling between UEs, such as the first UE 202 and/or the second UE 204, and other NFs. The SMF 230, for example, is generally responsible for managing sessions between the network and one or more UEs, such as the first UE 202 and the second UE 204. The PCF 242, for example, is generally responsible for providing and enforcing policy information, such as the restrictions and requirements of subscriber agreements.

NFs within the core network 218 communicate a variety of messages to each other to perform their associated functions. For example, messages may correspond to registering a UE (such as the first UE 202 and the second UE 204) with the network, registering of a service provided by an NF, requesting information from the destination NF, providing information to the source NF, subscribing to notifications from an NF, providing notifications to NFs that an event has occurred, requesting deletion of specific information stored by an NF, and the like. Information given or provided by NFs to other NFs may include subscription information associated with a particular subscriber of the network, session information associated with a particular session in the network, and/or information associated with authentication of a UE (such as the first UE 202 and the second UE 204).

The NFs within the core network 218 communicate with other NFs to perform specified functions via designated interfaces. An interface is a connection point between NFs and allows NFs to bi-directionally communicate messages to other NFs. Particular interfaces are associated with specific NF pairs. For example, communications between the AMF 224 and the SMF 230 occur on an N11 interface, while communications between the SMF 230 and the PCF 242 occur on an N7 interface. Further, for example, communications between the PCF 242 and the UDR 222 occur on an N36 interface, while communications between the UDM 220 and the UDR 222 occur on an Nudr interface. Essentially, which interface a message will travel across depends on which NFs the message is between.

In certain instances, an operator may wish to leverage the network environment 200 in order to integrate an application (e.g., application 250) as a native application, for example, after verifying that the application 250 on the UE 202 is a native application or on a list of approved applications. Integrating the application 250 as a native application on the first UE 202 may involve a series of steps.

Initially, the AMF 224 may undertake authentication of the UE 202, ensuring its identity and authorization within the core network 218. This authentication process may involve verifying the credentials of the first UE 202, which may include a unique identifier of the first UE 202, as discussed previously. Upon successful authentication, the SMF 230 may assume responsibility and provide an identifier to the first UE 202, such as a session identifier or a device identifier that will be associated with the first UE 202. In aspects where the identifier is a session identifier, the provided session identifier may be used to identify a specific session or connection between the first UE 202 and the core network 218, and the session identifier may be a temporary identifier associated with a particular interaction or session between the first UE 202 and the core network 218. In some aspects, the provided session identifier may be an IP address associated with the first UE 202. In aspects where the identifier is a device identifier, the provided device identifier may refer to more permanent identifiers relative to the session identifier. In some aspects, the provided device identifier may also be an IP address associated with the first UE 202.

Following the assignment of identifier to the first UE 202, which is different from the unique identifier (e.g., MSISDN) of the first UE 202, the SMF 230 may forward this identifier to the PCF 242. Upon receiving the assigned identifier of the first UE 202, the PCF 242 may write this information into the UDR 222, helping to ensure its centralized storage and accessibility. For example, the PCF 242 may have the ability to perform SBI HTTP2 POST to write the assigned identifier into the UDR 222 on the N36 interface. After receiving the assigned identifier of the first UE 202, the UDR 222 may perform a mapping operation to map the assigned identifier of the first UE 202 to the unique identifier of the first UE 202 in the communication network.

Now, the application 250 that is intended for integration as a native application may establish, or use a previously established, connection 252 to communicate with the UDR 222 on the Nudr interface, thereby facilitating seamless communication between the application 250 and the UDR 222 and enabling data requests and retrievals. To facilitate communication between the application 250 and the UDR 222, a new API may be developed that serves as a bridge between the host server 251 of the application 250 and the UDR 222 through the Nudr interface, helping to enable various data exchange operations. In some aspects, the connection 252 may be an API between the host server 251 and the UDR 222 that leverages the Nudr interface.

While the connection is established, the application 250 may initiate a request to retrieve the unique identifier stored in the UDR 222 based on the assigned identifier. This request may be sent to the host server 251. Upon receiving the request, the host server 251 may use the developed API to interact with the UDR 222. The host server 251 formulates a request for the UDR 222 using this API (e.g., the connection 252), which is then transmitted over the Nudr interface to the UDR 222. Once the UDR 222 receives the request, it processes it and provides the application 250 with the unique identifier.

For example, the assigned identifier, previously assigned to the first UE 202 during the attachment process, may be accessible to the application 250 before integration whereas the unique identifier may not be. Upon receiving the request, the UDR 222 may access its database and retrieve the unique identifier associated with the first UE 202 based on the previously established mapping between the assigned identifier and the unique identifier of the first UE 202. The unique identifier may then be provided to the application 250 as discussed above. Equipped with the unique identifier provided by the UDR 222, the application 250 may finalize the integration process of becoming a native application, gaining native-like access and functionality within the network environment 200. The application 250 may utilize the unique identifier to initiate a data call to a destination user equipment such as the second UE 204.

Additionally, the host server 251 may also maintain a mapping of the unique identifier and the assigned identifier of the UE 202, which helps enable the efficient retrieval of the assigned identifier of the UE 202 for future operations. For example, when the application 250 is restarted, it may use the stored unique identifier to query the UDR 222 for the assigned identifier. Such a setup may help optimize the process of managing UE 202 interactions by automatically providing the application 250 with updated mapping information (e.g., retrieving the assigned identifier) as necessary for the future operations.

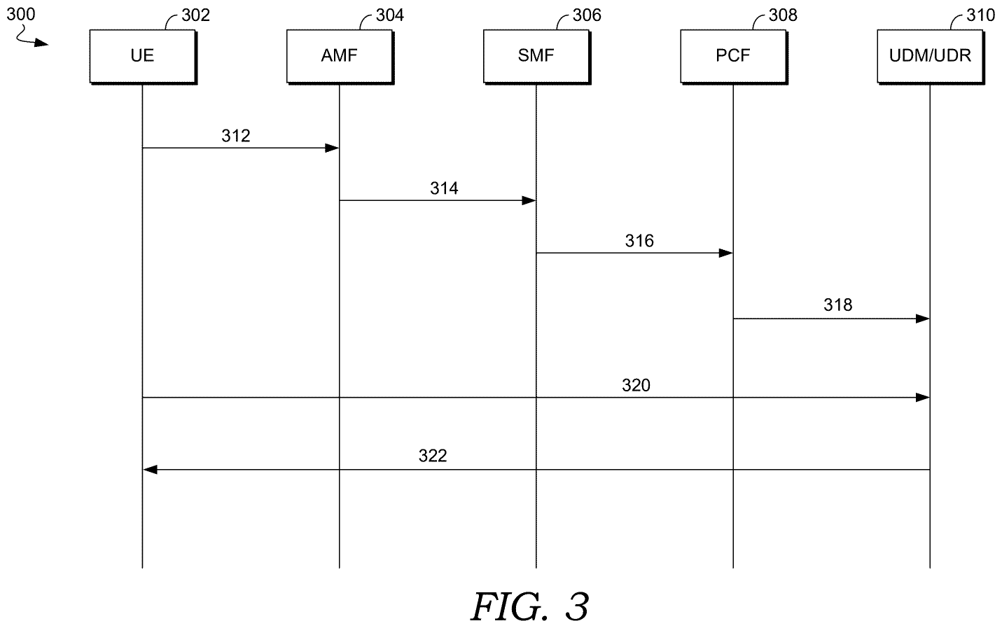

Turning now to FIG. 3, a flow diagram is illustrated in accordance with one or more aspects of the present disclosure. A flow diagram 300 may be said to exist between one or more NFs discussed in greater detail herein and is not meant to exhaustively show every interaction that would be necessary to practice the invention, so as not to obscure the present disclosure, but is instead meant to illustrate one or more potential interactions between NFs and a user equipment. The flow diagram 300 may be relevantly said to include a UE 302, a AMF 304, a SMF 306, a PCF 308, and a UDR 310. In some aspects, the UE 302 may be the same or similar to the first UE 202, the AMF 304 may be the same or similar to the AMF 224, the SMF 306 may be the same or similar to the SMF 230, the PCF 308 may be the same or similar to the PCF 242, and the UDR 310 may be the same or similar to the UDR 222. Notably, the preceding nomenclature is used with respect to the 3GPP 5G architecture; in other aspects, each of the preceding NF components may take different forms, including consolidated or distributed forms that perform the same general operations.

FIG. 3 illustrates an example method for storing a unique user equipment identifier (e.g., a MSISDN) of a user equipment on a communication network and retrieving the unique identifier for use by an application on the user equipment. At a first step 312, the UE 302 sends an attachment request to a communication network and attaches to the communication network comprising the NFs. In response to the attachment request, the AMF 304 may authenticate the UE 302 for service in the communication network. At a step 314, the SMF 306 may assign an identifier (e.g., an IP address) to the UE 302 and may also communicate the assigned identifier back to the UE 302, which may be accessed by an application on the UE 302 (e.g., application 250). At a step 316, the SMF 306 may forward the assigned identifier to the PCF 308 (e.g., sending ‘npcf_smpolycontrol’ update message with member field as “ipv6AddressPrefix” or “ipv6AddressPrefix” towards PCF 308). At a step 318, the PCF 308 may write the assigned identifier into the UDR 222 and the UDR 222 may maintain a mapping of the assigned identifier to the unique identifier of the UE 302. Additionally, the PCF 308 may have the ability to perform SBI HTTP2 POST to updated the assigned identifier into the UDR 310.

At a step 320, the application (e.g., application 250) on the UE 302 may receive a user input to initiate a call at the application and the UE 302 may receive a request from the application on the UE 302 to initiate the call. The application, and the UE 302, may request a configuration to initiate the call from the communication network (e.g., through an interface with the UDR 222), and the request may include the assigned identifier, which is different than the unique identifier. The request to initiate the call may also include a request to receive the unique identifier of the UE 302 in order to initiate the call. The communication network may receive the request from the application on the UE 302 and the communication network may verify that the application is a native application or that the application is on a list of approved applications for retrieval of the unique identifier. Following verification, the communication network may retrieve the unique identifier from the UDR 222 based on the request including the assigned identifier.

At a step 322, the unique identifier of the UE 302 may be provided to the UE 302, which may provide the unique identifier to the application on the UE 302. After receiving the unique identifier from the communication network (e.g., UDR 222), the application may utilize the unique identifier to initiate the data call to a destination user equipment (e.g., UE 204) using the unique identifier. In some aspects, received unique identifier may also be used for multi-factor authentication purposes on the application to more fully integrate the application as a native application on the UE 302.

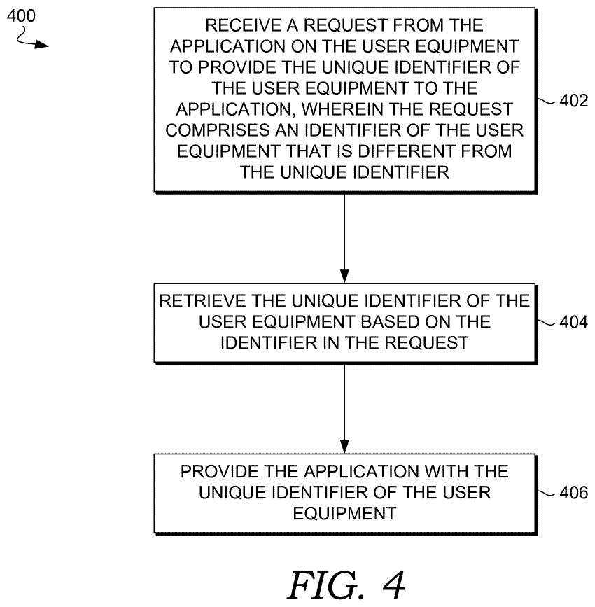

Turning now to FIG. 4, a flow chart is provided that illustrates one or more aspects of the present disclosure relating to a method 400 for providing an application on a user equipment with a unique identifier of the user equipment. At a first step 402, a communication network receives a request from the application on the user equipment to provide the unique identifier of the user equipment to the application, wherein the request comprises an identifier of the user equipment that is different from the unique identifier. At a second step 404, the communication network retrieves the unique identifier of the user equipment based on the identifier in the request. At a third step 406, the communication network provides the application with the unique identifier of the user equipment.

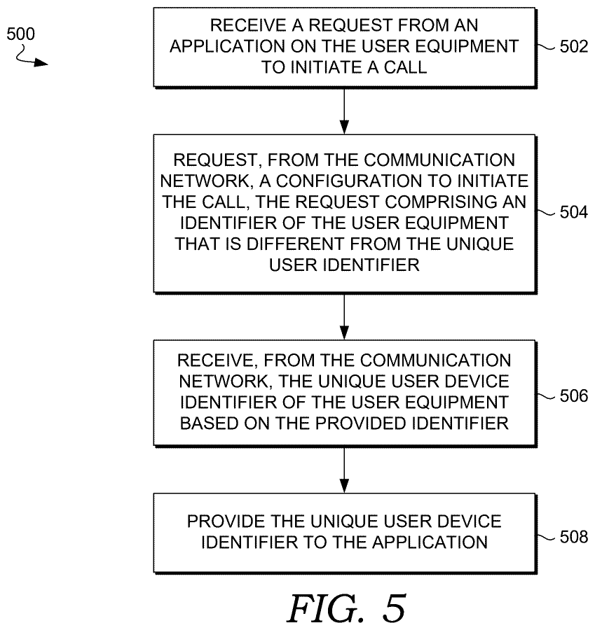

Turning now to FIG. 5, a flow chart is provided that illustrates one or more aspects of the present disclosure relating to a method 500 for retrieving a unique user equipment identifier from a communication network. In some aspects of the present disclosure, the method 500 may be performed by a user equipment in a communication network. For example, at a first step 502, the user equipment may receive a request from an application on the user equipment to initiate a call. At a second step 504, the user equipment may request, from the communication network, a configuration to initiate the call, the request comprising an identifier of the user equipment that is different from the unique user identifier. At a third step 506, the user equipment may receive, from the communication network, the unique user device identifier of the user equipment based on the provided identifier. At a fourth step 508, the user equipment may provide the unique user device identifier to the application.

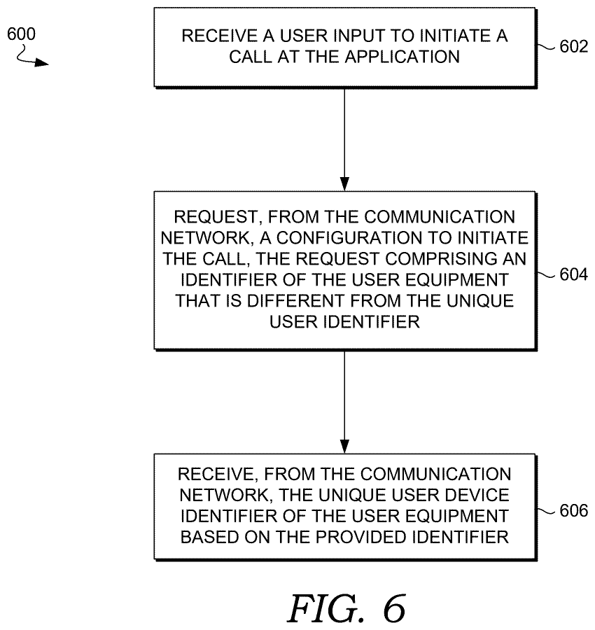

Turning now to FIG. 6, a flow chart is provided that illustrates one or more aspects of the present disclosure relating to a method 600 for retrieving a unique user equipment identifier from a communication network for use in an application on a user equipment. In some aspects of the present disclosure, the method 600 may be performed by an application on a user equipment in a communication network. For example, at a first step 602, a user input is received to initiate a call at the application. At a second step 604, the application may request, from the communication network, a configuration to initiate the call, the request comprising an identifier of the user equipment that is different from the unique user identifier. At a third step 606, the application may receive, from the communication network, the unique user device identifier of the user equipment based on the provided identifier. Additional steps may include initiating the call to a destination user equipment using the unique identifier received from the communication network.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. A system for providing an application on a user equipment with a unique identifier of the user equipment, the system comprising:
a network storage device;
a network device comprising one or more processors; and
a non-transitory computer-readable media comprising executable instructions that, when executed, causes the network device to perform operations in a communication network, the executable instructions comprising the steps of:
receiving a request from the application on the user equipment to provide the unique identifier of the user equipment to the application, wherein the request comprises an identifier of the user equipment that is different from the unique identifier;
retrieving the unique identifier of the user equipment based on the identifier in the request; and
providing the application with the unique identifier of the user equipment.

2. The system of claim 1, wherein executing the instructions further comprises receiving an attachment request from the user equipment to access the communication network and, in response to the attachment request, assigning the identifier to the user equipment.

3. The system of claim 2, wherein executing the instructions further comprises mapping the assigned identifier to the unique identifier in the communication network.

4. The system of claim 3, wherein the mapping is stored in a unified data repository (UDR) in the communication network and the unique identifier is retrieved from the UDR based on the request comprising the identifier.

5. The system of claim 1, wherein executing the instructions further comprises verifying that the application on the user equipment is a native application.

6. The system of claim 1, wherein executing the instructions further comprises verifying that the application on the user equipment is on a list of approved applications for retrieval of the unique user equipment identifier.

7. The system of claim 1, wherein the provided identifier is an internet protocol (IP) address, and wherein the received unique user equipment identifier is a mobile station international subscriber directory number (MSISDN) associated with the user equipment.

8. The system of claim 1, wherein the provided identifier is a mobile station international subscriber directory number (MSISDN), and wherein the received unique user equipment identifier is an internet protocol (IP) address.

9. A non-transitory computer-readable media comprising executable instructions that, when executed, causes a user equipment comprising one or more processors to perform operations for retrieving a unique user equipment identifier from a communication network, the executable instructions comprising the steps of:
receiving a request from an application on the user equipment to initiate a call;
requesting, from the communication network, a configuration to initiate the call, the request comprising an identifier of the user equipment that is different from the unique user identifier;
receiving, from the communication network, the unique user device identifier of the user equipment based on the provided identifier; and
providing the unique user equipment identifier to the application.

10. The computer-readable media of claim 9 further comprising sending an attachment request to the communication network.

11. The computer-readable media of claim 10 further comprising receiving the identifier of the user equipment in response to the attachment request.

12. The computer-readable media of claim 9 further comprising verifying that the application on the user equipment is a native application or on a list of approved applications for retrieval of the unique user equipment identifier.

13. The computer-readable media of claim 9, wherein the provided identifier is an internet protocol (IP) address, and wherein the received unique user equipment identifier is a mobile station international subscriber directory number (MSISDN) associated with the user equipment.

14. The computer-readable media of claim 13, wherein executing the instructions further comprises initiating a data call to a destination user equipment using the MSISDN.

15. A method for retrieving a unique user equipment identifier from a communication network for use in an application on a user equipment, the method comprising:
receiving a user input to initiate a call at the application;
requesting, from the communication network, a configuration to initiate the call, the request comprising an identifier of the user equipment that is different from the unique user equipment identifier; and
receiving, from the communication network, the unique user device identifier of the user equipment based on the provided identifier.

16. The method of claim 15, wherein the provided identifier is a session identifier associated with the user equipment.

17. The method of claim 16, wherein the session identifier is an internet protocol (IP) address associated with the user equipment.

18. The method of claim 17, wherein the received unique user equipment identifier is a mobile station international subscriber directory number (MSISDN) associated with the user equipment.

19. The method of claim 15, wherein the provided identifier is a device identifier associated with the user equipment.

20. The method of claim 15, wherein the provided identifier is a mobile number associated with the user equipment and the received unique user equipment identifier is an internet protocol (IP) address associated with the user equipment.
